(19) United States
(12) Patent Application Publication
(10) Pub. No.: US 2006/0273001 A1
(43) Pub. Date: Dec. 7, 2006

(54) Spacer element for guiding flow media

(76) Inventor: Wilhelm Heine, Hamburg (DE)

Correspondence Address: Klaus J. Bach, 4407 Twin Oaks Drive, Murrysville, PA, 15668, US

(21) Appl. No.: 11/187,153

(22) Filed: Jul. 23, 2005

(30) Foreign Application Priority Data
Jun. 6, 2005 (EP) 05 012 133.4

(51) Int. Cl. B01D 27/00

(52) U.S. Cl. 210/450; 210/455; 210/335; 210/321.6

(57) ABSTRACT

In a spacer element for guiding a flow medium in apparatus for filtering and separating the flow medium by reverse osmosis and ultrafiltration wherein filter elements are disposed between adjacent spacer elements which are disc-shaped and each has a central opening with a plurality of spaced openings disposed around the central opening for conducting the flow medium through the spacer element, a plurality of projections extend from the surfaces of the spacer element and have support areas formed at their tops which are oriented essentially parallel to the side surfaces of the spacer element.

### BACKGROUND OF THE INVENTION

The invention relates to a spacer element for guiding flow media, particularly in an apparatus for filtering and separating flow media by reverse osmosis and ultra-filtration, wherein between two essentially plate-like spacer elements, which are provided with central openings and around which the flow medium flows, a filter element is disposed and, around the central opening, a plurality of spaced openings is arranged through which the flow medium passes and wherein a plurality of projections are disposed on the surface of the spacer elements.

Such a spacer element is known from EP-A-0 289 740. These spacer elements have been used for decades in apparatus for filtering and separating flow media, particularly in the desalination of sea water and seepage water treatment as it occurs for example in waste depositories but also in the separation of compounds from liquid mixtures in chemical processing plants, particularly in crude oil processing plants.

The principle of separating materials with such apparatus which use spacer elements and filter elements disposed between the spacer elements in the form of membrane pillows is well-known in the art and does not need to be explained herein in detail.

In the known apparatus, the membrane pillows are not in direct contact with the surface of the spacer element, but are supported on a plurality of projections so that a space is formed between the surface of the membrane pillows through which the flow medium, or, respectively, the sea water or the contaminated seepage water can flow along the surfaces of the membrane pillows and the selected part of the flow medium can permeate the membrane pillow and the permeate can be collected in the closed membrane pillow and conducted to an outlet while the flow medium is increasingly concentrated during passage from the inlet to the outlet which it leaves as retentate.

The driving force for this separating mechanism is the primary pressure of the flow medium to be separated which is conducted through the apparatus along a meandering path. Between the inlet pressure of the flow medium and the discharge pressure of the retentate leaving the apparatus, there is a substantial pressure loss which is greater the more filter elements are disposed in the apparatus around which the flow medium is conducted in passing through the apparatus.

Depending on the size of the apparatus, the membrane surface area, the type of membranes and the flow medium to be separated and also the selected separating mechanism, inlet pressures of 50 to 60 bar or even 120 to 150 bar may be used which results in a high mechanical load of the membrane pillow sheets which consist of a polymer material. It is also to be taken into consideration that such apparatus are operated continuously for extended periods that is the mechanical stress of the membranes is extremely high.

With membrane pillows disposed between spacer elements, it is desirable that the projections on which the membrane pillows are supported are as small as possible so that for the flow medium, the resistance caused by the support elements which do not contribute to the material separation and also the pressure losses can be kept as small as possible and areas or points where particles suspended in the flow medium can be deposited and finally cause flow blockages and a reduction of the effective membrane surface area can be eliminated as much as possible.

In the known spacer elements, the projections have therefore the form of elevation with rounded tops. With this shape of the projections, the selective layer of the membrane pillows abuts the projections with a surface area which theoretically approaches zero. As a result, the selective surface area of the membrane elements is as large as possible and the flow and pressure lowering area of the projections is as small as possible.

It has been found however, that, because of the very high primary pressures with which such devices are operated, the membrane elements move slightly also because of the elasticity of the polymer material of which the membrane elements are formed. There is therefore during operation of such devices particularly at the support points of the membrane pillows, that is at the tips of the projections, mechanical wear which, during extended operation of the device, will not only result in an impression in the selective layer of the membrane pillow but in a piercing of the selective layer of the membrane pillow. This instantly results in failure of the whole apparatus since the flow medium can no longer be separated as the retentate mixes with the permeate.

Furthermore, the polymer material which forms the selective layer of the membrane pillow becomes increasingly softer with increasing temperature so that with increasing temperature of the flow medium to be separated, it becomes more likely that, as a result of the friction mechanism between the surface of the projections and the selective layer of the membrane element described above, the element is pierced.

If the apparatus becomes inoperative as a result of the piercing of the selective layer of the membrane pillow, a spare apparatus is needed which can takeover operation. However, in many cases, it is impossible to provide such a redundant apparatus for many reasons, for example, cost, space, and servicing reasons among others.

It is therefore the object of the present invention to provide a spacer element of the type as referred to above, which, while retaining the advantages of these spacer elements, does not cause damage to the surface of the selective layers of a membrane pillow even during an extended operation of the apparatus under high pressures and at high temperatures. Also, the basic design principles of the apparatus in which the spacer element is employed should not need to be changed so that the spacer element can be installed in an apparatus already in operation, that is, the spacer element should be usable also in an other apparatus which are not different in principle. Also, the spacer element should be simple so that it can be manufactured easily and at reasonable expenses.

### SUMMARY OF THE INVENTION

In a spacer element for guiding a flow medium in apparatus for filtering and separating the flow medium by reverse osmosis and ultra-filtration wherein filter elements are disposed between adjacent spacer elements which are disc-shaped and each has a central opening with a plurality of spaced openings disposed around the central opening for conducting the flow medium through the spacer element, a plurality of projections extend from the surfaces of the spacer element and have support areas formed at their tops which are oriented essentially parallel to the side surfaces of the spacer element.

Such a spacer element has the advantage over the spacer elements described above that the membrane pillow is supported on the adjacent surface area of the projection, which is small as required, and not on a very small point as it is the case with the conventional spacer elements.

In a particular advantageous embodiment of the spacer element, the projections have an essentially flat top surface. This provides for the positive effect that the adjacent corresponding surface area of the membrane pillow which is also essentially flat is supported on the flat surface of the projections over the full extension thereof. As a result, the area-specific engagement forces are substantially reduced so that mechanical stresses caused by the movement of the membrane pillow and by thermal influences will not result in damage to the selective membrane layers even over an extended operation of the apparatus.

The probability of damage is advantageously further reduced in that the projections flat top surface is rounded around its edges so that, even if the selective layer of the membrane pillow is slightly bent over the edges of the projection top surface, which may be caused by mechanical movement as a result of the fluid flow through the apparatus and/or additionally, the temperature of the fluid, the selective layer of the membrane pillow is not damaged.

The surfaces of the projections as such may have different shapes adjacent the membrane pillows. However, it has been found to be advantageous if the projections have in a direction normal to the surface of the spacer element an essentially trapezoidal cross-section. This has the advantage that the flow medium can be conducted around the projection with low resistance.

The top surface of the projection may have an essentially rectangular contour or an essentially trapezoidal contour wherein the longer side of the rectangular or trapezoidal contour extends in the flow direction of the flow medium and the shorter side of the rectangular or trapezoidal contour extends transverse to the flow direction.

The distribution of the projections on the surface of the spacer element has been found to be problematic. Although, in the known spacer elements, the projections are arranged in a certain order that is in accordance with a certain scheme on the surface of the spacer element, this distribution or, respectively, scheme is so selected that a linear flow of the flow medium over the surface of the spacer element cannot be obtained. Rather, the flow medium is conducted back and forth or in a stepped fashion over the surface. This increases the hydraulic resistance for the flow medium with regard to the arrangement of the projections on the surface of the spacer element. This is disadvantageous particularly because the effectiveness of the separation of the flow medium is not increased thereby. In order to eliminate this disadvantage, the projections are arranged in accordance with an advantageous embodiment of the invention, on the surface in the form of rays extending from the center of a central opening, so that the flow medium can flow through the radial spaces between the projections without any resistance and without being deflected back and forth or in a step-like pattern.

The projections are arranged on the surface preferably at matrix dots of a plurality of different circles with different radii, starting out at the center of the central opening. In this way, it is made sure that the distances between one projection and the adjacent projections are the same at least in the flow direction over the surface of the spacer element, so that it is ensured that the membrane pillow disposed thereon is uniformly supported by the projections.

In a further advantageous embodiment of the spacer element, the points of adjacent circles on which the projections are located are displaced in order to provide for an even more secure support of the membrane pillow with the least possible number of projections on the surface of the spacer element.

The number of projections on one surface can be selected to be different from that on the other surface whereby different pressures of the flow medium on the surface on one side with respect to the surface on the other side as a result of a reversal of the flow direction of the flow medium can be accommodated.

In accordance with still another advantageous embodiment of the invention, a plurality of spaced openings is provided around the central opening through which the flow medium passes. In this way, the flow of the flow medium in one direction as well as the other direction after the flow reversal following passage through the openings is essentially uninhibited wherein the openings which provide for communication between the two surfaces of the spacer element in the area of the central hole may be considered a sink for the flow medium at one side of the spacer plate and a source for the flow medium at one side of the spacer plate from where the flow medium flows over the next spacer plate surface.

It is also advantageous if a projecting web is arranged between every two spaced openings so as to project from the spacer element. This ensures that the openings are not blocked by the membrane pillows by a pressure build up within the membrane pillows because of the out-flowing permeate. In this way, the membrane pillow remains exposed or open in these critical areas adjacent the openings.

On the surface of the webs which extend essentially parallel to the surface of the spacer element in each case at least one raised projection is provided which has essentially the same shape as the projections which are provided directly on the surfaces of the spacer element.

The spacer element itself may consist of any suitable material which is lightweight and provides for a high strength of the spacer element.

Preferably, the spacer element consists of a plastic material for example of a plastic material which can be injection molded, preferably of polyoxymethylene (POM). This plastic material has the extraordinary advantage that, in contrast to the materials used conventionally for spacer elements, it has a very high temperature resistance and a higher mechanical strength. As a result, the thickness of the spacer element can be substantially reduced and the edge areas of the spacer element can also be narrower and lighter. Consequently, substantial savings in weight and expenses can be realized in comparison with conventional apparatus using the conventional spacer elements. An apparatus of the same size using the spacer elements according to the present invention can accommodate more spacer elements and more membrane pillows in the same spaces occupied by conventional apparatus so that the active membrane separating surface area of the apparatus can be increased and the expenses reduced.

It is also possible to make the spacer elements according to the invention from conventional plastic materials such as polystyrol (PS), acrylnitrile butadiene-styrol-copolymers (ABS) or styrol-acrylnitrile-copolymers (SAN), wherein this solution may be used if existing apparatus are to be refurbished and equipped at least partially with the new spacer elements. Preferably, the filter element is in the form of a membrane pillow which includes at least at one side thereof a membrane element which forms the material-selective layer. With this membrane element, the targeted material which in this case is water can permeate and is collected in the interior of the membrane between the two outer layers and then flows to a permeate discharge opening formed in the membrane pillow. However, in order to fully utilize the membrane surface of a membrane pillow, it is advantageous if the membrane pillow comprises a membrane element at both sides. In this embodiment, the membrane pillow may include different membrane elements with different material-selective properties so that the flow of the targeted medium or the permeate passed through the membrane elements by permeation can be influenced in a certain way.

In apparatus which are equipped with conventional spacer elements, membranes pillows have been used which have an octagonal outer configuration. Generally, membrane elements with the material selective layer and possibly with one or several intermediate layer or layers were manufactured by ultrasonic welding apparatus which could not weld membrane pillows of other shapes. As a result, apparatus including such membrane pillows were not suitable for circular spacer elements. Certain areas of the spacer element were therefore not covered by the membrane pillow.

In accordance with the present invention, the membrane pillow for the spacer elements according to the invention has an essentially circular contour so that the membrane surface area per spacer element is substantially increased without the need for changing the apparatus and the spacer element. Also, existing apparatus can be equipped with the spacer elements and membrane pillows according to the invention without essential reconstruction measures. As a result, the apparatus can be used for the separation of flow media more effectively which also results in a reduction of the costs for the operation of such an apparatus.

Below the invention will be described in greater detail with reference to the accompanying drawings on the basis of a particular exemplary embodiment.

### BRIEF DESCRIPTION OF THE DRAWINGS

FIG. 1 is a cross-sectional view of an apparatus for the filtering and separation of a flow medium with a filter stack formed by a plurality of spacer elements and filter elements,

FIG. 2 is a top view of a spacer element,

FIG. 3 is a top view of a spacer element partially cut-away showing the side opposite that shown in FIG. 2,

FIG. 4 is a top view showing the central opening area of the spacer elements according to FIGS. 2 and 3 in an enlarged representation,

FIG. 5 is a side view of a spacer element according to FIGS. 2 to 4 in an enlarged representation,

FIG. 6 shows the detail E of FIG. 5 in an enlarged representation and in a sectional partial view,

FIG. 7 is a top view of a number of projections on a portion of the spacer element and,

FIG. 8 is a partial and cross-sectional view of the spacer element of FIG. 7.

### DESCRIPTION OF A PREFERRED EMBODIMENT

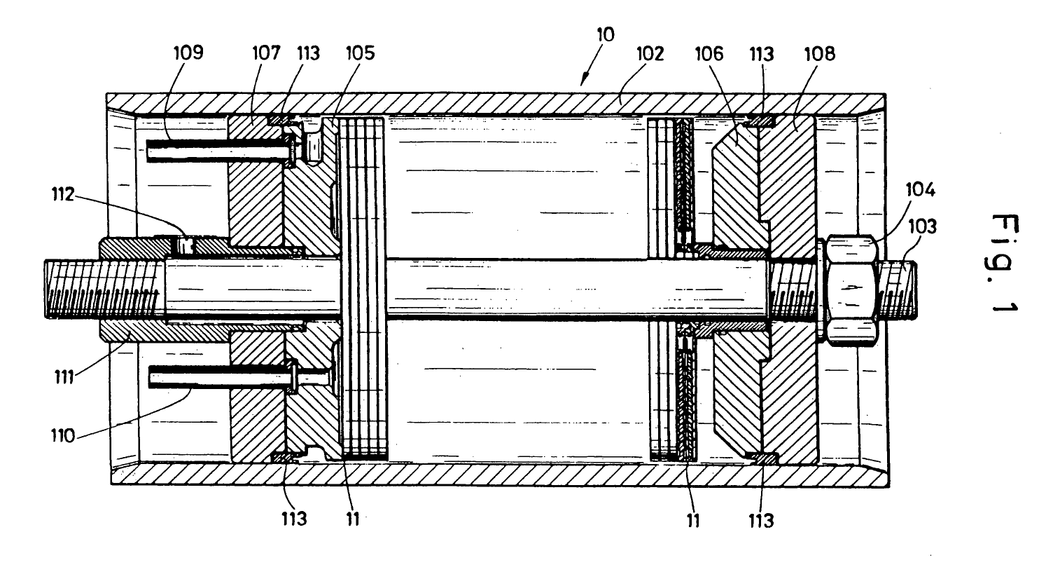

FIG. 1 shows an apparatus for filtering and separating flow media by reverse osmosis and ultrafiltration, wherein in the apparatus 10 a plurality of filter elements 13 in the form of membrane pillows and spacer elements 11 are stacked up in a filter stack of predetermined length.

It is noted at this point that the apparatus 10 as shown in FIG. 1 and as described reprsents an example. Other design features may be used in the design of the apparatus 10 which are not disclosed herein. The spacer elements 11 may be installed also with design features different from those disclosed herein.

Nevertheless, for a betting understanding of the spacer element 11 according to the invention in connection with a filter element 13 in the form of a membrane pillow the whole apparatus 10 will be shortly described below.

The apparatus 10 includes essentially a tubular housing 102. The housing 102 includes alternately spacer elements 11 and filter elements 13, that is between every two spacer elements 11, a filter element 13 is disposed. Only at the opposite ends of the filter element stack, the spacer element 11 is not provided with a filter element 11. At the connecting end of the filter element stack, there is an end disc 106. On the connection disc 105, an outer connecting flange 107 is disposed whereas an outer end flange 108 is disposed on the end disc 106. The filter element stack and the other elements referred to above are held together by a central clamping bolt 103 which extends through corresponding central openings of these elements and which is provided at opposite ends with nuts 104 and 111 threaded onto corresponding thread portions of the bolt 103 for containing the interior of the housing 102. Through the outer connecting flange 107, an inlet line 109 extends for the admission of flow medium 15 and also an outlet line 110 extends for the discharge of the flow medium from the apparatus.

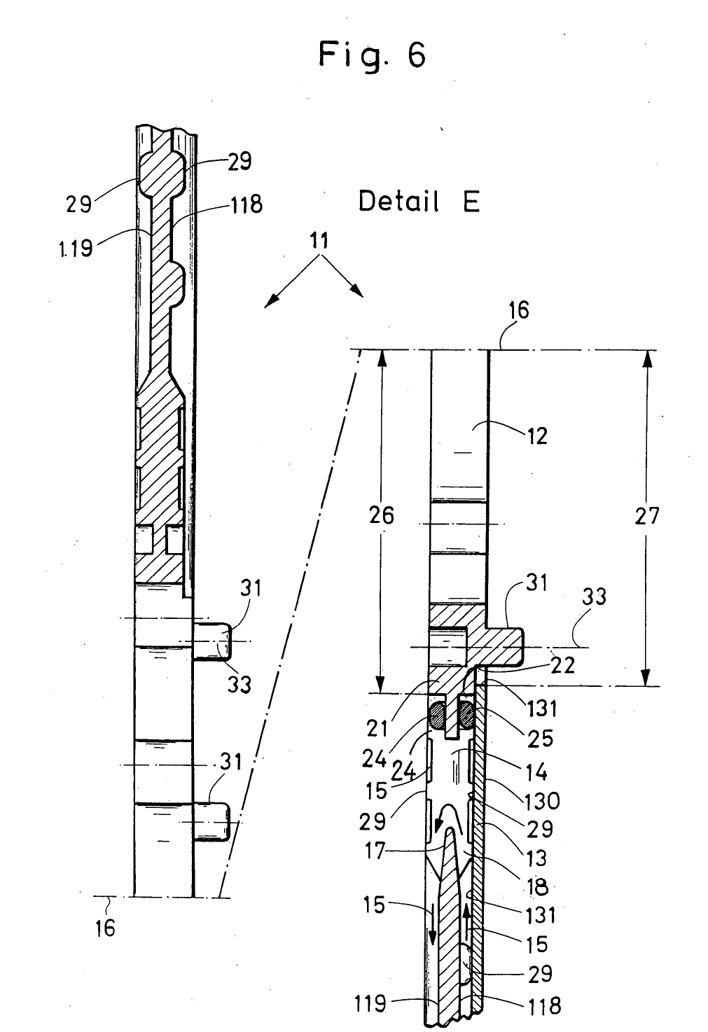

A flow medium 15 entering through the inlet 109 reaches the interior of the housing 102, that is, it flows into the gap between the filter element stack and the interior wall of the housing 102. Through this gap, the flow medium reaches the space between the end disc 106 and the adjacent spacer element 11. The flow medium 11 and along the inner surface 119 (FIG. 6) of the spacer element 11. From there, the flow medium is redirected around a filter element 13 inserted between the spacer element 11 and the adjacent spacer element and then returns toward the center of the housing 102 where it flows then through the openings 14 of the second spacer element 11. From there, the flow medium 15 flows outwardly and is again redirected in the same way around the outer edge of the next adjacent spacer element 11 and so on up to the end of the filter element stack. From the central permeate flow opening or respectively the front sides of the membrane pillow filter element 13, the permeate finally exits along the central clamping bolt 102 and flows along the clamping bolt 103 to the permeate discharge opening 112 to the outside for further treatment. The concentrated flow medium or retentate 15 reaches after flowing through the whole filter element stack in a meander-like fashion, an annular collection area which is formed around the connection disc 105 and flows from there to the outside via the outlet duct 110. The filter element stack is supported in the housing 102 by suitable seals 113.

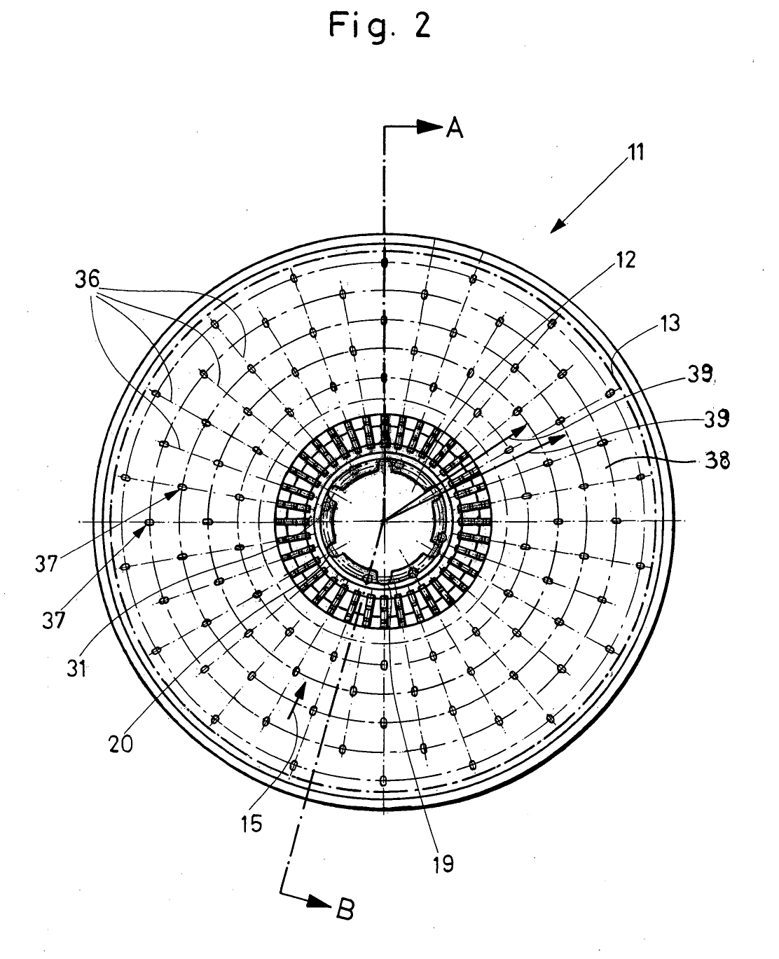

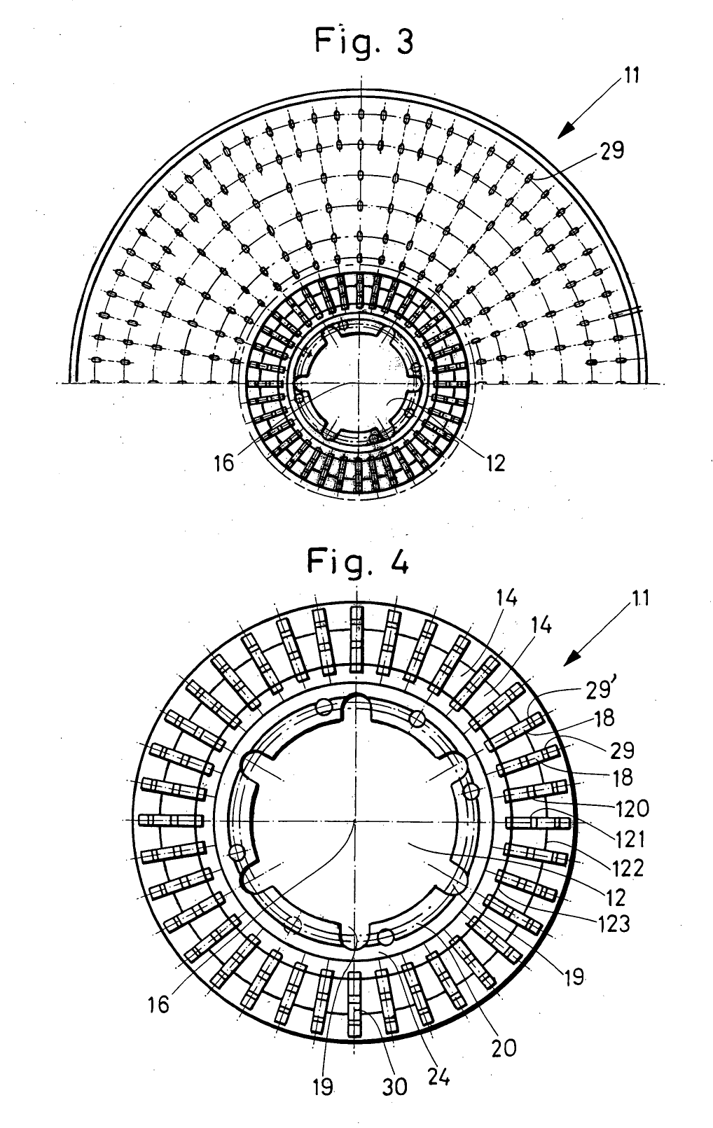

FIGS. 2 to 4 are plan views of the spacer element 11 wherein FIG. 2 shows one side of the whole spacer element 11, whereas FIG. 3 shows only a section of the other side of the spacer element 11 and FIG. 4 is a plain view of the center area of the spacer element 11 without the surrounding plate-like part of the spacer element 11.

This spacer element 11 is used in connection with the filter element stack described earlier in connection with the apparatus 10. The spacer element 11 has in the exemplary embodiment described herein a circular shape and is delimited by two disc-shaped surfaces 118, 119. The axis 16 thereof extends along the center of the central opening 12. Around the central opening 12, the spacer element 11 includes a plurality of spaced openings 14 through which the flow medium 15 flows—see also FIG. 6—which will be described in greater detail further below. In the embodiment described herein the openings 14 are disposed on a certain circle at essentially the same distance from the center 16 of the central opening 12.

The openings 14 have a slot-like shape and a trapezoidal structure in cross-section. The longitudinal sides 120, 121 of the slot-like openings 14 are longer than the transverse sides 122, 123. In an area which is radially directly adjacent the openings 14 and becomes narrower toward the central opening 12, the thickness of the spacer element 11 becomes smaller toward the central opening 12, see reference numeral 17 in FIG. 6. The tip of the narrowing structure 17 may be rounded.

Between the spaced openings 14, there is a web 18, which projects normally from the surfaces 118, 119 of the spacer. The central opening 12 is provided at its circumferential area with a plurality of permeate discharge passages 19. The permeate discharge passages 19 extend into a permeate discharge flow duct structure 20 which extends around the central opening 12 at a predetermined distance, see particularly FIG. 4. The permeate discharge flow structure 20 is delimited by an extension 21, see FIG. 6, which is part of the spacer element 11. The extension 21 projects at one face 119 from the spacer element 11.

Around the central opening 12, there is a groove-like recess 22, 23 provided at both surfaces 118, 119 see particularly FIG. 6 for the reception of seal rings 24, 25. These seal rings 24, 25 are shown in FIG. 6 disposed in frictional engagement in the groove-like recesses 22, 23. The radial distance 26 of the recesses 22 from the center 16 of the opening 12 is greater than the radial distance 27 between the opening center 16 and the inner edge of a central permeate discharge opening of the membrane pillow filter element 13.

The filter element 13 in the form of a membrane pillow as shown herein has a circular circumference but it may have another shape for example that of a multiple cornered body. The filter element 13 in the form of a membrane pillow is in any case a disc which has such an outer contour that it can be disposed on a surface 118, 119 of the spacer element 11 without sealingly covering the area at its outer edge 34, 35, which delimits the spacer element outwardly. As already mentioned, the flow medium 15 can be redirected after flowing along the filter element 13 in order to reach flowing below the filter element 13 along the surface 18 to the opening 14 and through the spacer element 11. The filter element 13 is shown in FIG. 2 represented by a dash-dotted line. The filter element 13 abuts with its central permeate discharge flow structure 20 the spacer element 11 co-axially with the center 16 of the opening 12, see FIGS. 2, 6.

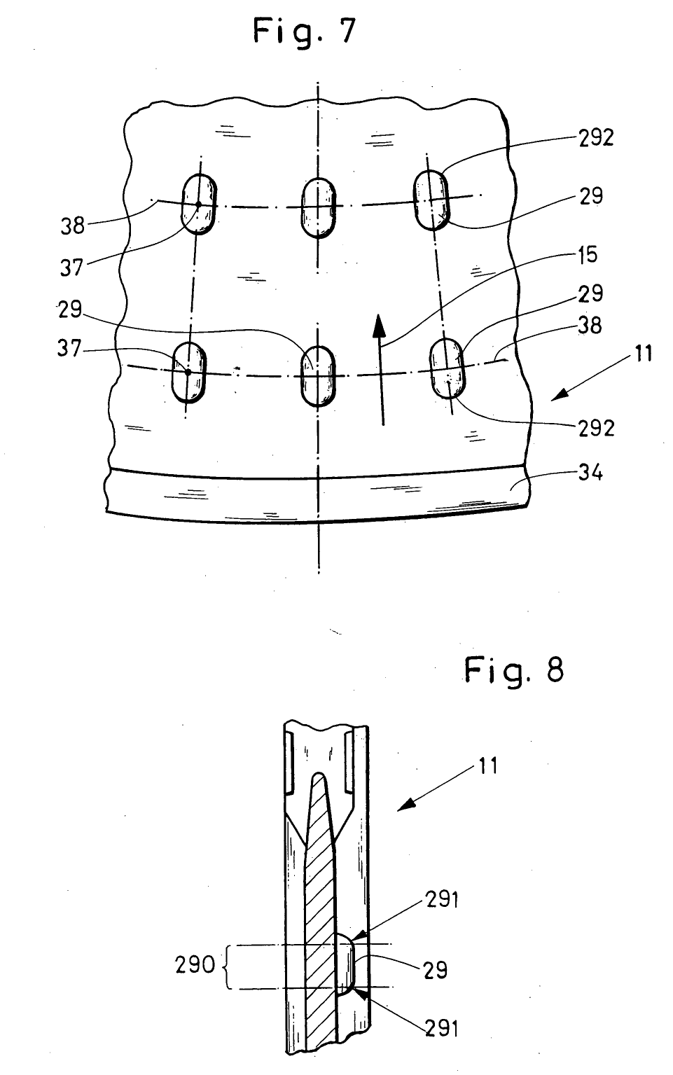

On both surfaces 118, 119 of the spacer element 11, a plurality of projections 29 are arranged which extend normally therefrom. The projections 29 have a surface 290 which extends essentially parallel to the respective surface 118, 119 of the projections 29, see particularly the enlarged representations according to FIGS. 7 and 8. The surfaces 290 of the projections 29 are essentially planar and rounded at their edges 291. The projections 29 have a trapezoidal cross-section in a direction normal to the surface 118, 119 and possibly also in a transverse direction and longitudinal direction with respect to the flow direction of the flow medium 15—see FIG. 8. The surface area 290 of the projections 29 is essentially rectangular, but may also be semi-circular along the narrow ends 292, see FIG. 7 or parabola shaped in order to prevent the smallest possible hydraulic resistance for the flow medium 15 flowing toward or away from, the projection, see the arrow with the reference manual 15 in FIGS. 2 to 7. The surface 290 of the projection may also have an essentially trapezoidal contour (not shown).

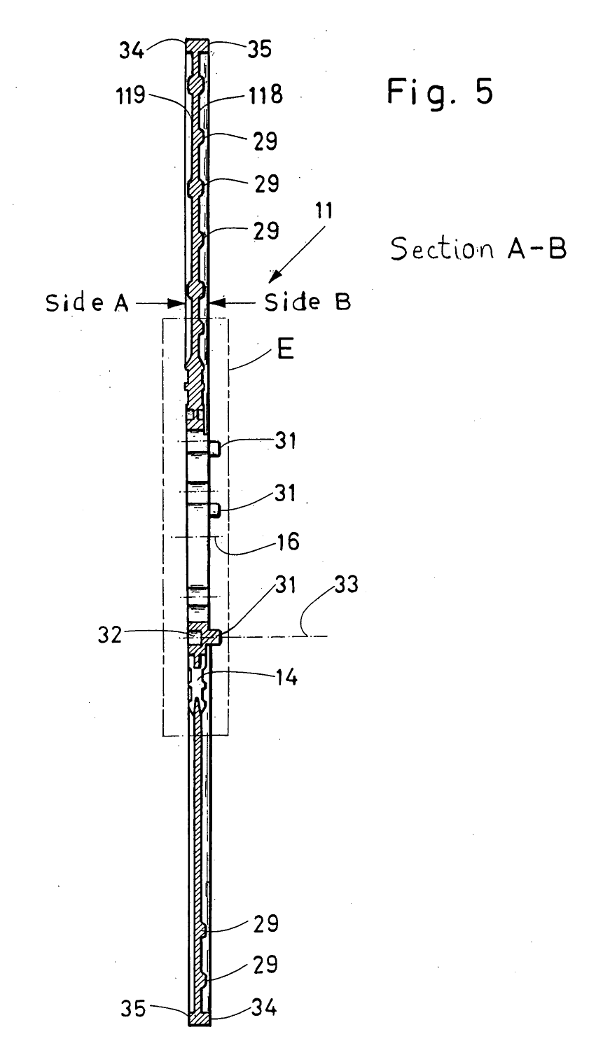

Also, on the web surfaces 30, which extend essentially parallel to the surfaces 118, 119 of the spacer element 11, projections 29′ are provided which extend from the surfaces 30. The projections 29′ however project only to such an extent that they reach the same height over the surfaces 118, 119 of the spacer element 11 as the projections 29 on the surfaces 118, 119. In this way, it is ensured that the filter element 13 is supported on all the projections 29, 29′ essentially parallel to the surfaces 118, 119 of the spacer element 11 and contact also the seal rings 24, 25 under sufficient tension as provided by the central clamping bolt 103 described earlier in connection with the apparatus 10 in a sealing fashion under slight deformation of the cross-section of the seal rings 24, 25 (see FIG. 5).

As apparent particularly from FIGS. 2 and 3 and the enlarged partial representation of FIG. 7, the projections 29 on the surfaces 118, 119 are arranged in a radial pattern 36 extending from the center 16 of the central opening 12. The projections 29 on the surface 118, 119 are arranged on pattern points 37 of a plurality of concentric circles 38 of different radii 39 centered at the center 16 of the central opening 12. The distance between adjacent circles 38 may be the same or it may be different.

As apparent from a comparison between FIGS. 2 and 3, the number of projections 29 on one of the surfaces 118, 119 with respect to the other of the surfaces 118, 119 may be different. Also, spacer elements may be used in each spacer element stack which are different from the earlier description of the devices 10 and which have a different number of projections 29 depending for example on the pressure differential between the inlet pressure of the flow medium at the inlet of the apparatus 10 and the much lower pressure at the outlet of the filter and spacer element stack through which the flow medium 15 passes.

The points 37 of adjacent circles 38 on which the projection 29 are located may also be displaced with respect to each other as shown in FIG. 2.

In the area around the central opening 12 on one of the surfaces 112 of the spacer element 11 a plurality of pin-like projections 31 are provided while a corresponding plurality of bores 32 is provided on the other surface 119. The projection 31 of a spacer element 11 and the bores 32 are disposed on the same axis 33 see FIG. 6, and are at the same distance from the center 16 of the opening 12. The projections 31 and the bores 32 of the spacer element 11 have generally the same cross-sectional shape for example a circular shape as shown in the embodiment described herein. The pin-like projections 31 of one spacer element 11 fit into the bores 32 of an adjacent spacer element 11 so that large spacer element stacks with membrane pillow filter elements 13 disposed between the spacer elements 11 can be assembled in a highly accurately aligned fashion.

Each spacer element includes an outer circumferential edge 34, 35 at both surfaces 118, 119, see FIG. 5, wherein one of the edges 34 is higher by an amount corresponding to the thickness of the membrane pillow filter element 13 with respect to a line extending normally to the surface 118 as apparent particularly from FIGS. 6 and 8. In the hollow disc-like space formed in this way, the filter element 13 is disposed as mentioned earlier. One surface 130 of the filter element 13, which in the representation of FIG. 6 is the lower, inner surface, abuts flatly the extension 21. Several spacer elements 11 when assembled as shown in FIG. 1 to a spacer and filter element stack enclose between adjacent spacer elements 11 a filter element 13 wherein one surface 113 of the filter element 13 is supported on the projections 29 of the one surface 118 of the spacer element 11 while the other surface 130 is supported on the projections 29 of the other surface 119 of the adjacent spacer element, etc. . . .

As already described initially, the flow medium flows meander-like on the surface 118 toward the opening 14, see FIGS. 4, 5, where its flow is reversed so that it flow along at the opposite surface 119 outwardly away from the opening 14. In the area of the outer limiting edges of the membrane pillow filter element 13, the flow medium 15 is again deflected to flow through the gap formed between the edge 34 of the one spacer element 11 and the edge 35 of the other spacer element 11 and then again inwardly toward the openings 14 of the adjacent spacer element 11.

By way of the material-selective separating layer of the filter element 13, undesirable compounds such as salt of sea water is separated from the flow medium 15 as the salt-free water permeates through the selective separating layer of the membrane pillow and is collected in the space between the two surfaces 130, 131. It finally exits through the outlet of the filter element 13 into the permeate discharge channel 20 and from flows there via the permeate discharge passages 19 along the clamping bolt 103, see FIG. 1, out of the apparatus 10 via the permeate discharge opening 12.

The spacer elements 11 preferably consists of the plastic material polyoximethylene (POM), whereby, on one hand, the spacer element 11 has a high strength and on the other hand, a high temperature stability in comparison with other plastic materials which could also be used. Additionally, POM is relatively lightweight.

Other plastic materials may be used for forming the spacer element 11 such as polystyrol (PS), acrylnitrile-butadine-styrol-copolymers (ABS) or also styrol-acryl-nitrile-copolymers (SAN).

Basically, however, the spacer elements 11 may also consist of metallic materials or a combination metal and plastic.

What is claimed is:

1. A spacer element (11) for guiding a flow medium (15) particularly in an apparatus (10) for filtering and separating the flow medium (15) by reverse osmosis and ultra-filtration, with a filter elements (13) disposed between two adjacent spacer elements (11), each spacer element (11) being disc-shaped and having a control opening (12) with a plurality of spaced openings (14) disposed around the central opening (12) for conducting the flow medium (15) through the spacer element (11), said spacer element (11) having opposite surfaces (118, 119), and a plurality of projections (29) extending from each surface (118, 119), said projections (29) having support areas (290) formed on top of the projections (29) oriented essentially parallel to the opposite surfaces (118, 119) of the spacer element (11).

2. A spacer element according to claim 1, wherein the support surface (290) is essentially planar.

3. A spacer element according to claim 2, wherein the support surface (290) has rounded edges (291).

4. A spacer element according to claim 2, wherein, with respect to the surfaces (118, 119) of the spacer element (11) orthogonal direction, the projections (29) have an essentially trapezoidal cross-section.

5. A spacer element according to claim 2, wherein the support surface area (290) has an essentially rectangular contour.

6. A spacer element according to claim 2, wherein the support surface area (290) has an essentially trapezoidal contour.

7. A spacer element according to claim 1, wherein the projections (29) are arranged on the surfaces (118, 119) of the spacer element (11) in a radial array centered at the center (16) of the central opening (12).

8. A spacer element according to claim 7, wherein the projections (29) are arranged on the surfaces (118, 119) along concentric circles (38) of different radii (39) the centers of the circles (28) coinciding with the center (16) of the central opening (12).

9. A spacer element according to claim 8, wherein the projections (29) are disposed at the intersection (37) between alternate radial lines of the radial array and alternate concentric circles (38).

10. A spacer element according to claim 1, wherein the number of projections (29) provided on one of the surfaces (118, 119) of the spacer element (21) is different from the number of projections (29) provided on the other of the surfaces (118, 119) of the spacer element (11).

11. A spacer element according to claim 1, wherein a plurality of spaced openings (14) are disposed around the central opening (12) in spaced relationship for the passage of the flow medium from one side thereof to the other.

12. A spacer element according to claim 11, wherein between two adjacent openings (14) a web (18) is disposed so as to project from the surfaces (118, 119) of the spacer element (11).

13. A spacer element according to claim 12, wherein the webs (18) have surfaces (30) which extend essentially parallel to the surfaces (118, 119) of the spacer element (11) and projections (29) are provided on the surfaces (30) of the webs (18).

14. A spacer element according to claim 1, wherein the spacer element (11) consists of plastic material.

15. A spacer element according to claim 14, wherein the plastic material is polyoximethylene (POM).

16. A spacer element according to claim 14, wherein the plastic material is one of polystyrol, PS, acrylnitrile-butadine-styrol-copolymer, ABS and styrol acrylnitrile copolymer, SAN.

17. A spacer element according to claim 1, wherein the filter element (13) is essentially circular.

18. A spacer element according to claim 1, wherein the filter elements (13) are in the form of membrane pillows.

19. A spacer element according to claim 18, wherein the membrane pillow (13) includes a membrane element at both sides thereof and the membrane element at one side of the membrane pillow (13) has a different material selectivity than that at the other side of the membrane pillow (13).
